(19) United States
(12) Patent Application Publication
(10) Pub. No.: US 2024/0127051 A1
(43) Pub. Date: Apr. 18, 2024

(54) COMPUTER-READABLE RECORDING MEDIUM STORING MACHINE LEARNING PROGRAM AND MACHINE LEARNING METHOD

(71) Applicant: Fujitsu Limited, Kawasaki-shi (JP)

(72) Inventor: Yasufumi SAKAI, Fuchu (JP)

(73) Assignee: Fujitsu Limited, Kawasaki-shi (JP)

(21) Appl. No.: 18/358,983

(22) Filed: Jul. 26, 2023

(30) Foreign Application Priority Data
Oct. 17, 2022 (JP) 2022-166277

(51) Int. Cl. G06N 3/08

(52) U.S. Cl. CPC G06N 3/08

(57) ABSTRACT

A non-transitory computer-readable recording medium stores a machine learning program for causing a computer to execute a process including: for a machine learning model that includes a plurality of preliminarily trained layers, a first output layer formed according to a downstream task and coupled to a final layer of the plurality of layers, and a plurality of second output layers that is coupled to respective outputs of layers other than the final layer of the plurality of layers and has a same configuration as the first output layer, training only the first output layer and the second output layer of the machine learning model using the downstream task; and training the entire machine learning model that includes the first output layer and the second output layer using the downstream task.

### CROSS-REFERENCE TO RELATED APPLICATION

This application is based upon and claims the benefit of priority of the prior Japanese Patent Application No. 2022-166277, filed on Oct. 17, 2022, the entire contents of which are incorporated herein by reference.

### FIELD

The embodiment discussed herein is related to a machine learning program and a machine learning method.

### BACKGROUND

In recent years, transfer learning utilizing a preliminarily trained model such as Bidirectional Encoder Representations from Transformers (BERT) has been implemented.

U.S. Patent Application Publication No. 2019/0095764, Japanese Laid-open Patent Publication No. 2020-119508, and Japanese Laid-open Patent Publication No. 2022-102095 are disclosed as related art.

### SUMMARY

According to an aspect of the embodiments, a non-transitory computer-readable recording medium stores a machine learning program for causing a computer to execute a process including: for a machine learning model that includes a plurality of preliminarily trained layers, a first output layer formed according to a downstream task and coupled to a final layer of the plurality of layers, and a plurality of second output layers that is coupled to respective outputs of layers other than the final layer of the plurality of layers and has a same configuration as the first output layer, training only the first output layer and the second output layer of the machine learning model using the downstream task; and training the entire machine learning model that includes the first output layer and the second output layer using the downstream task.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a functional configuration of a model generation device as an exemplary embodiment;

FIG. 2 is a block diagram illustrating a hardware configuration of a computer that implements functions of the model generation device as the exemplary embodiment;

FIG. 3 is a diagram for explaining a backbone generated by a backbone generation unit of the model generation device as the exemplary embodiment;

FIG. 4 is a diagram for explaining an early-exit-directed model generated by an early-exit-directed model generation unit of the model generation device as the exemplary embodiment;

FIG. 5 is a flowchart for explaining a model generation method by the model generation device as the exemplary embodiment;

FIG. 6 is a flowchart for explaining a method of training a training target model by a first fine-tuning processing unit and a second fine-tuning processing unit of the model generation device as the exemplary embodiment;

FIG. 7 is a diagram illustrating inference accuracy of a model trained by the model generation device as the exemplary embodiment in comparison with a model trained by an existing method;

FIG. 8 is a diagram illustrating the inference accuracy of the model trained by the model generation device as the exemplary embodiment in comparison with the model trained by the existing method;

FIG. 9 is a flowchart illustrating a first variation of the method of training a training target model by the first fine-tuning processing unit and the second fine-tuning processing unit;

FIG. 10 is a flowchart illustrating a second variation of the method of training a training target model by the first fine-tuning processing unit and the second fine-tuning processing unit; and

FIG. 11 is a diagram exemplifying a preliminarily trained model to which an early exit is applied.

### DESCRIPTION OF EMBODIMENTS

In the transfer learning, a part of a machine learning model that has been trained (machine learning) using a preliminary training task is changed according a task (downstream task) that a user wants to perform. The machine learning model trained using the preliminary training task may be referred to as a preliminarily trained model. For example, an output layer of the preliminarily trained model may be replaced with an output layer adapted to the downstream task. The downstream task may be referred to as a lower task.

In the transfer learning, the preliminarily trained model in which a part of the output layer or the like is changed according to the downstream task in this manner is retrained using the downstream task. The retraining of the preliminarily trained model using the downstream task may be referred to as fine-tuning.

As a transfer learning method of the machine learning model, for example, a technique of training only a classifier included in a preliminarily trained model and a technique of training the entire preliminarily trained model in the fine-tuning have been known.

There has been a need to improve inference accuracy of the machine learning model in such an existing transfer learning method.

In one aspect, an object of the embodiment is to improve inference accuracy of a machine learning model.

Hereinafter, an embodiment related to the present machine learning program and machine learning method will be described with reference to the drawings. Note that the embodiment to be described below is merely an example, and there is no intention to exclude application of various modifications and techniques not explicitly described in the embodiment. For example, the present embodiment may be variously modified (by combining the embodiment and each of modifications, etc.) and implemented without departing from the spirit of the present embodiment. Furthermore, each drawing is not intended to include only components illustrated in the drawing, and may include another function and the like.

### (A) RELATED ART

There has been known an early exit as a method of achieving high inference speed of a neural network.

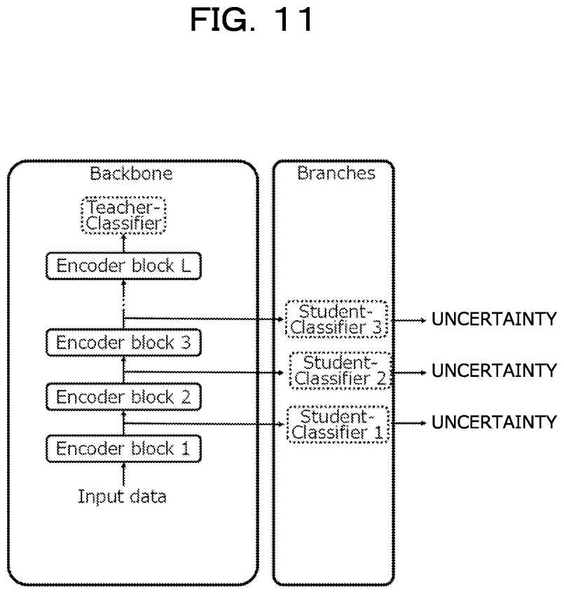

FIG. 11 is a diagram exemplifying a preliminarily trained model to which the early exit is applied.

FIG. 11 illustrates a basic model including a plurality (L in the example illustrated in FIG. 11) of layers (Encoder blocks) and a final layer classifier (Teacher-Classifier). This basic model may be referred to as a backbone. Furthermore, the preliminarily trained model to which the early exit is applied may be referred to as an early exit application model.

Each of the plurality of layers in the backbone may be an encoder, and those plurality of layers may be repeatedly stacked in the backbone. Each of the plurality of layers in the backbone has been preliminarily trained using a preliminary training task.

A classifier configured according to a downstream task is coupled to the final layer of the backbone instead of the classifier used in the preliminary training. The classifier coupled to the final layer has an untrained (e.g., random) parameter before the start of training (in the initial state).

Furthermore, a classifier (Student-Classifier) having the same configuration as the classifier coupled to the final layer is coupled to an output of each of the individual layers included in the backbone. The classifier coupled to each of those outputs may be referred to as a branch.

In such an early exit application model, uncertainty of inference data is calculated using the output of each classifier at the time of inference. When the calculated uncertainty satisfies a predetermined threshold, prediction of the classifier is set as a final result, and the inference data is not caused to flow to a layer at a subsequent stage, whereby the inference may be speeded up.

Furthermore, fine-tuning for the early exit application model is carried out in a similar manner to fine-tuning for the preliminarily trained model to which the early exit is not applied. For example, in the fine-tuning, training using the downstream task is performed on the backbone and the branch at a time. As a result, training of preliminarily trained parts (individual layers) in the backbone and training of individual untrained classifiers (Teacher-Classifier and Student-Classifier) are carried out simultaneously.

However, the inference accuracy of the early exit application model having been subject to the fine-tuning in this manner is lower than that of a model without the early exit.

This is considered to be due to the fact that each of the individual classifiers of the branches and the classifier coupled to the final layer of the backbone has a random parameter that has not been trained, and gradients back-propagated from those classifiers become larger in the fine-tuning so that the large gradients adversely affect the parameters of the individual layers.

In a neural network, task inference needs to be carried out highly accurately, and it is not desirable to reduce the model inference accuracy instead of achieving shortening of a training time by transfer learning.

Furthermore, while the early exit is a method for achieving high-speed inference by outputting an inference result in a shallow layer of a model, the inference accuracy in the shallow layer needs to be improved to output the inference result in the shallow layer of the model. For example, when the inference accuracy is lowered, the high-speed inference based on the early exit may not be achieved.

The present model generation device 1 carries out the fine-tuning for the early exit application model without causing performance deterioration.

### (B) EMBODIMENT

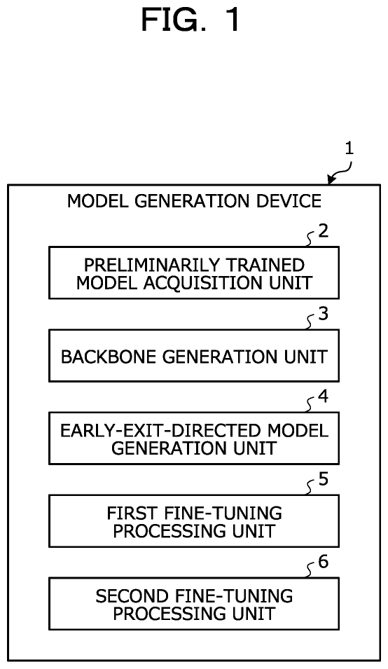

FIG. 1 is a diagram illustrating a functional configuration of the model generation device 1 as an exemplary embodiment.

The present model generation device 1 generates an early exit application model. The present model generation device 1 generates an early-exit-directed model based on the basic model (backbone) created using the transfer learning. Moreover, the present model generation device 1 carries out the fine-tuning for the generated early-exit-directed model. The basic model is a neural network.

(B-1) Exemplary Hardware Configuration

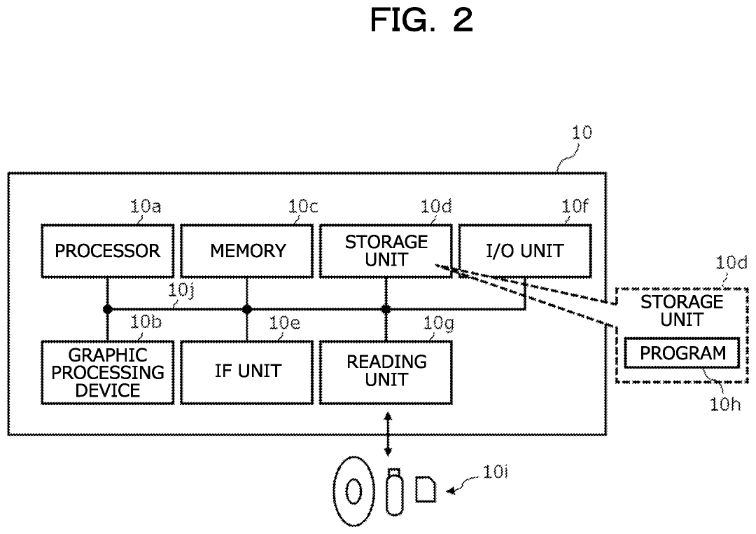

FIG. 2 is a block diagram illustrating a hardware (HW) configuration of a computer 10 that implements functions of the model generation device 1 as the exemplary embodiment. In a case of using a plurality of computers as HW resources for implementing the functions of the model generation device 1, each of the computers may have the HW configuration exemplified in FIG. 2.

As illustrated in FIG. 2, the computer 10 may illustratively include a processor 10a, a graphic processing device 10b, a memory 10c, a storage unit 10d, an interface (IF) unit 10e, an input/output (I/O) unit 10f, and a reading unit 10g as the HW configuration.

The processor 10a is an exemplary arithmetic processing device that performs various types of control and operations, which is a control unit that performs various types of processing. The processor 10a may be communicably coupled to each block in the computer 10 via a bus 10j. Note that the processor 10a may be a multiprocessor including a plurality of processors, or a multi-core processor including a plurality of processor cores, or may have a configuration including a plurality of multi-core processors.

As the processor 10a, for example, integrated circuits (ICs) such as a CPU, an MPU, an APU, a DSP, an ASIC, and an FPGA are exemplified. Note that a combination of two or more of those integrated circuits may be used as the processor 10a. The CPU is an abbreviation for a central processing unit, and the MPU is an abbreviation for a micro processing unit. The APU is an abbreviation for an accelerated processing unit. The DSP is an abbreviation for a digital signal processor, the ASIC is an abbreviation for an application specific IC, and the FPGA is an abbreviation for a field-programmable gate array.

The graphic processing device 10b performs screen display control on an output device such as a monitor of the I/O unit 10f. Furthermore, the graphic processing device 10b may have a configuration as an accelerator that executes machine learning processing and inference processing using a machine learning model. As the graphic processing device 10b, various arithmetic processing devices, for example, integrated circuits (ICs) such as a graphics processing unit (GPU), an APU, a DSP, an ASIC, and an FPGA are exemplified.

The memory 10c is exemplary HW that stores information such as various types of data and programs. As the memory 10c, for example, one or both of a volatile memory such as a dynamic random access memory (DRAM) and a nonvolatile memory such as a persistent memory (PM) are exemplified.

The storage unit 10d is exemplary HW that stores information such as various types of data and programs. As the storage unit 10d, various storage devices such as a magnetic disk device such as a hard disk drive (HDD), a semiconductor drive device such as a solid state drive (SSD), and a nonvolatile memory are exemplified. As the nonvolatile memory, for example, a flash memory, a storage class memory (SCM), a read only memory (ROM), and the like are exemplified.

The storage unit 10d may store a program 10h (machine learning program) that implements all or a part of various functions of the computer 10.

For example, the processor 10a of the model generation device 1 loads the program 10h stored in the storage unit 10d into the memory 10c and executes it, thereby implementing a model generation function for training the machine learning model.

The IF unit 10e is an exemplary communication IF that performs control of coupling and communication between the present computer 10 and another computer, and the like. For example, the IF unit 10e may include an adapter conforming to a local area network (LAN) such as Ethernet (registered trademark), optical communication such as a fibre channel (FC), or the like. The adapter may support one or both of wireless and wired communication systems.

For example, the model generation device 1 may be coupled to another information processing device (not illustrated) in a mutually communicable manner via the IF unit 10e and a network. Note that the program 10h may be downloaded from the network to the computer 10 via the communication IF, and may be stored in the storage unit 10d.

The I/O unit 10f may include one or both of an input device and an output device. As the input device, for example, a keyboard, a mouse, a touch panel, and the like are exemplified. As the output device, for example, a monitor, a projector, a printer, and the like are exemplified. Furthermore, the I/O unit 10f may include a touch panel or the like in which the input device and the output device are integrated. The output device may be coupled to the graphic processing device 10b.

The reading unit 10g is an exemplary reader that reads information regarding data and programs recorded in a recording medium 10i. The reading unit 10g may include a coupling terminal or a device to which the recording medium 10i may be coupled or inserted. As the reading unit 10g, for example, an adapter conforming to a universal serial bus (USB) or the like, a drive device that accesses a recording disk, a card reader that accesses a flash memory such as a secure digital (SD) card, and the like are exemplified. Note that the program 10h may be stored in the recording medium 10i, and the reading unit 10g may read the program 10h from the recording medium 10i and store it in the storage unit 10d.

As the recording medium 10i, for example, non-transitory computer-readable recording media such as a magnetic/optical disk and a flash memory are exemplified. As the magnetic/optical disk, for example, a flexible disk, a compact disc (CD), a digital versatile disc (DVD), a Blu-ray disc, a holographic versatile disc (HVD), and the like are exemplified. As the flash memory, for example, semiconductor memories such as a USB memory and an SD card are exemplified.

The HW configuration of the computer 10 described above is an example. Therefore, an increase or decrease in the HW (e.g., addition or deletion of any block), division, integration in any combination, addition or deletion of the bus, or the like in the computer 10 may be appropriately performed.

(B-2) Exemplary Functional Configuration

As illustrated in FIG. 1, the present model generation device 1 may illustratively have functions as a preliminarily trained model acquisition unit 2, a backbone generation unit 3, an early-exit-directed model generation unit 4, a first fine-tuning processing unit 5, and a second fine-tuning processing unit 6. Those functions may be implemented by the hardware of the computer 10 (see FIG. 2).

The preliminarily trained model acquisition unit 2 obtains a preliminarily trained model. The preliminarily trained model acquisition unit 2 may train a machine learning model using a preliminary training task to generate (obtain) a preliminarily trained model. Furthermore, the preliminarily trained model acquisition unit 2 may obtain a preliminarily trained model generated (prepared) by another information processing device, for example, via a network or the like.

The preliminarily trained model may be a neural network model. The preliminarily trained model may include a plurality of layers (Encoder blocks) and a final layer classifier (Teacher-Classifier).

The preliminarily trained model acquisition unit 2 stores information regarding the obtained preliminarily trained model in a predetermined storage area of the storage unit 10d or the like.

The backbone generation unit 3 generates a backbone (basic model) adapted to a downstream task based on the preliminarily trained model obtained (generated) by the preliminarily trained model acquisition unit 2.

The backbone generation unit 3 replaces an output layer (e.g., classifier) coupled to the final layer of the plurality of layers included in the preliminarily trained model configured according to the preliminary training task using a new output layer (second output layer: new classifier) formed according to the downstream task, thereby generating a backbone.

The new output layer (new classifier) in this backbone may have, for example, a random parameter as an initial state.

The backbone generation unit 3 stores information regarding the generated backbone in a predetermined storage area of the storage unit 10d or the like.

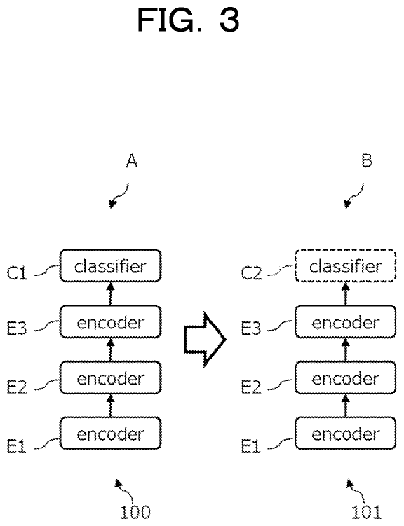

FIG. 3 is a diagram for explaining the backbone generated by the backbone generation unit 3 of the model generation device 1 as the exemplary embodiment.

In this FIG. 3, a reference sign A denotes a preliminarily trained model 100 obtained (generated) by the preliminarily trained model acquisition unit 2, and a reference sign B denotes a backbone 101 generated by the backbone generation unit 3 based on the preliminarily trained model 100 denoted by the reference sign A.

The preliminarily trained model 100 denoted by the reference sign A includes three layers of encoders E1 to E3, and a classifier C1 coupled to the final layer encoder E3 of those three layers of encoders E1 to E3. The classifier C1 corresponds to the output layer. The preliminarily trained model 100 may be, for example, a model preliminarily trained with huge data.

The backbone generation unit 3 replaces the classifier C1 of the preliminarily trained model 100 with a classifier C2 configured according to the downstream task, thereby generating the backbone 101. The classifier C2 corresponds to a first output layer.

For the preliminarily trained model 100 including the encoders E1 to E3, which are the plurality of preliminarily trained layers, the backbone generation unit 3 replaces the classifier C1 (output layer) coupled to the final layer encoder E3 of those encoders E1 to E3 with the classifier C2 (first output layer) formed according to the downstream task.

The early-exit-directed model generation unit 4 couples, to each of outputs of the plurality of layers (intermediate layers) included in the backbone generated by the backbone generation unit 3, a classifier (Student-Classifier: second output layer layer) having the same configuration as the classifier (first output layer) coupled to the final layer of the backbone, thereby generating an early-exit-directed model.

Each of the individual classifiers (first output layer and second output layer) included in the early-exit-directed model may be referred to as a head. Each of the respective classifiers (heads) in the early-exit-directed model is a layer (untrained layer) with an untrained (e.g., random) weight.

The early-exit-directed model generation unit 4 stores information regarding the generated early-exit-directed model in a predetermined storage area of the storage unit 10d or the like.

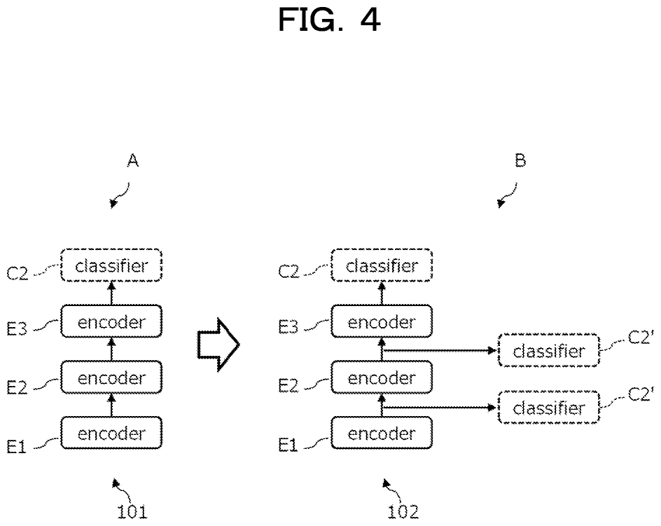

FIG. 4 is a diagram for explaining the early-exit-directed model generated by the early-exit-directed model generation unit 4 of the model generation device 1 as the exemplary embodiment.

In FIG. 4, a reference sign A denotes the backbone 101 generated by the backbone generation unit 3, and a reference sign B denotes an early-exit-directed model 102 generated by the early-exit-directed model generation unit 4 based on the backbone 101 denoted by the reference sign A.

The early-exit-directed model generation unit 4 couples a classifier C2′ having the same configuration as the classifier C2 to each of respective outputs of the encoders E1 and E2 to which the classifier C2 is not coupled among the encoders E1 to E3 of the three layers included in the backbone 101 denoted by the reference sign A. In this manner, the early-exit-directed model generation unit 4 generates the early-exit-directed model 102 based on the backbone 101.

The early-exit-directed model generation unit 4 couples the classifier C2′ (second output layer) having the same configuration as the classifier C1 (first output layer) to each of the respective outputs the layers other than the final layer (E1 and E2) among the plurality of layers (encoders E1 to E3) of the backbone 101, thereby generating the early-exit-directed model 102 (machine learning model).

The first fine-tuning processing unit 5 performs, using the downstream task, training (fine-tuning) on each of the individual classifiers included in the early-exit-directed model generated by the early-exit-directed model generation unit 4.

For example, the first fine-tuning processing unit 5 trains only the classifier (first output layer) C2 and the classifier (second output layer) C2′ included in the early-exit-directed model using the downstream task. The first fine-tuning processing unit 5 trains only untrained heads in the early-exit-directed model using the downstream task.

The training of each head by the first fine-tuning processing unit 5 may be carried out using a known method. The first fine-tuning processing unit 5 carries out the training by repeatedly performing, on each of the individual heads, each processing of forward propagation, loss function calculation, back propagation, and weight update in this order until a termination condition is satisfied, for example.

Here, in the forward propagation, training data (downstream task) is input to a head (classifier), and a calculation result is output from an output layer of the head.

Furthermore, in the loss function calculation, a loss function is calculated using the calculation result from the output layer of the head. In the back propagation, a gradient of each layer is calculated from the output layer to the input layer of the head using the calculated loss function. In the weight update, a weight value of each layer is updated using the calculated gradient.

The termination condition may be, for example, performing a series of processing including the forward propagation, the loss function calculation, the back propagation, and the weight update the number of times of training set by the user.

The training (fine-tuning) using the downstream task for each of the individual classifiers included in the early-exit-directed model by the first fine-tuning processing unit 5 is carried out prior to the training using the downstream task for the entire early-exit-directed model by the second fine-tuning processing unit 6 to be described later.

The second fine-tuning processing unit 6 performs, using the downstream task, training (fine-tuning) of all the classifiers trained by the first fine-tuning processing unit 5 and each preliminarily trained intermediate layer included in the early-exit-directed model generated by the early-exit-directed model generation unit 4.

For example, the second fine-tuning processing unit 6 trains, using the downstream task, the entire early-exit-directed model including all the classifiers trained by the first fine-tuning processing unit 5.

The training of the entire early-exit-directed model by the second fine-tuning processing unit 6 may be carried out in a similar manner to the training of each classifier by the first fine-tuning processing unit 5. For example, the second fine-tuning processing unit 6 may carry out the training by repeatedly performing, on the entire early-exit-directed model, each processing of the forward propagation, the loss function calculation, the back propagation, and the weight update in this order until the termination condition is satisfied, for example.

(B-3) Operation

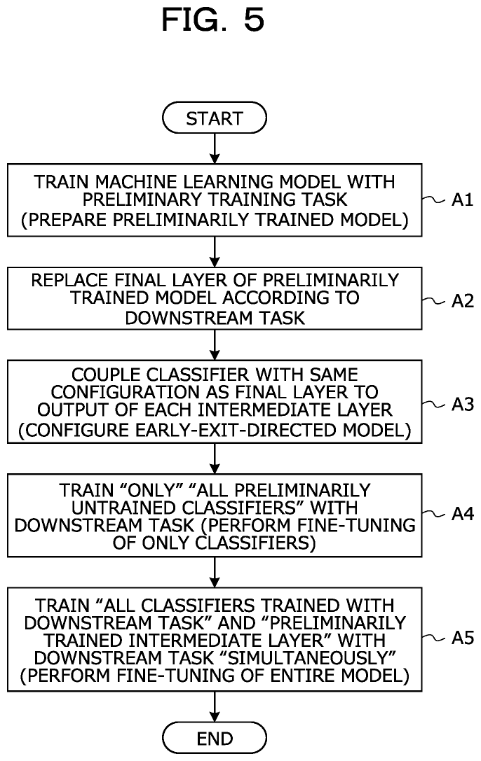

A method of model generation by the model generation device 1 configured as the exemplary embodiment described above will be described according to a flowchart (steps A1 to A5) illustrated in FIG. 5.

In step A1, the preliminarily trained model acquisition unit 2 generates (obtains) a preliminarily trained model by, for example, training a machine learning model using a preliminary training task.

In step A2, the backbone generation unit 3 replaces a final layer (classifier) of the preliminarily trained model configured according to the preliminary training task using a final layer (classifier) configured according to a downstream task, thereby generating a backbone.

In step A3, the early-exit-directed model generation unit 4 couples, to each of outputs of individual intermediate layers included in the backbone generated by the backbone generation unit 3, a classifier having the same configuration as the classifier coupled to the final layer of the backbone, thereby generating an early-exit-directed model.

In step A4, the first fine-tuning processing unit 5 trains only untrained heads (classifiers) in the early-exit-directed model using the downstream task.

In step A5, the second fine-tuning processing unit 6 trains, using the downstream task, all the classifiers trained by the first fine-tuning processing unit 5 and each preliminarily trained intermediate layer included in the early-exit-directed model generated by the early-exit-directed model generation unit 4 at a time. For example, the second fine-tuning processing unit 6 performs fine-tuning of the entire early-exit-directed model simultaneously. Thereafter, the process is terminated.

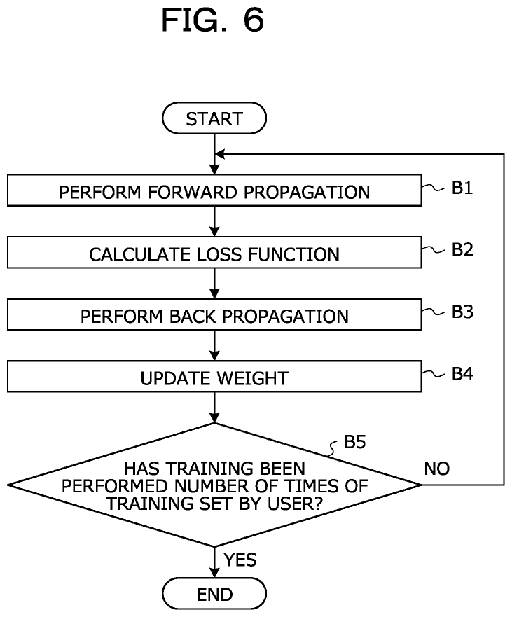

Next, a training method of a training target model by the first fine-tuning processing unit 5 and the second fine-tuning processing unit 6 of the model generation device 1 as the exemplary embodiment will be described according to a flowchart (steps B1 to B5) illustrated in FIG. 6.

Note that the training target model of the first fine-tuning processing unit 5 is an untrained head (classifier) in the early-exit-directed model, and the training target model of the second fine-tuning processing unit 6 is the entire early-exit-directed model.

In step B1, the first fine-tuning processing unit 5 or the second fine-tuning processing unit 6 carries out forward propagation in which training data (downstream task) is input to a model (classifier) and a calculation result is output from an output layer.

In step B2, the first fine-tuning processing unit 5 or the second fine-tuning processing unit 6 calculates a loss function using the calculation result from the output layer.

In step B3, the first fine-tuning processing unit 5 or the second fine-tuning processing unit 6 carries out back propagation in which a gradient of each layer is calculated from the output layer to the input layer using the calculated loss function.

In step B4, the first fine-tuning processing unit 5 or the second fine-tuning processing unit 6 updates a weight value of each layer using the calculated gradient.

In step B5, the first fine-tuning processing unit 5 or the second fine-tuning processing unit 6 checks whether the process in steps B1 to B4 has been performed the number of times of training set by the user. For example, the first fine-tuning processing unit 5 or the second fine-tuning processing unit 6 checks whether a termination condition is satisfied.

If the process in steps B1 to B4 has not been performed the number of times of training set by the user as a result of the checking (see NO route of step B5), it is determined that the termination condition is not satisfied, and the process returns to step B1.

On the other hand, if the process in steps B1 to B4 has been performed the number of times of training set by the user (see YES route of step B5), it is determined that the termination condition is satisfied, and the process is terminated.

(B-4) Effects

As described above, according to the model generation device 1 as the exemplary embodiment, first, the first fine-tuning processing unit 5 trains only untrained heads (classifiers) in an early-exit-directed model using a downstream task. Thereafter, the second fine-tuning processing unit 6 simultaneously performs fine-tuning of the entire early-exit-directed model.

As a result, all classifiers in the backbone have been trained by the first fine-tuning processing unit 5 at the time of the fine-tuning of the entire early-exit-directed model performed by the second fine-tuning processing unit 6.

Therefore, at the time of the fine-tuning of the entire early-exit-directed model performed by the second fine-tuning processing unit 6, a gradient back-propagated from each classifier becomes smaller, whereby adverse effect of the gradient back-propagated from each classifier on the parameter of each layer of the backbone may be suppressed. Accordingly, it becomes possible to suppress a decrease in accuracy of the fine-tuned early exit application model. Furthermore, as a result thereof, it becomes possible to speed up inference by the fine-tuned early exit application model.

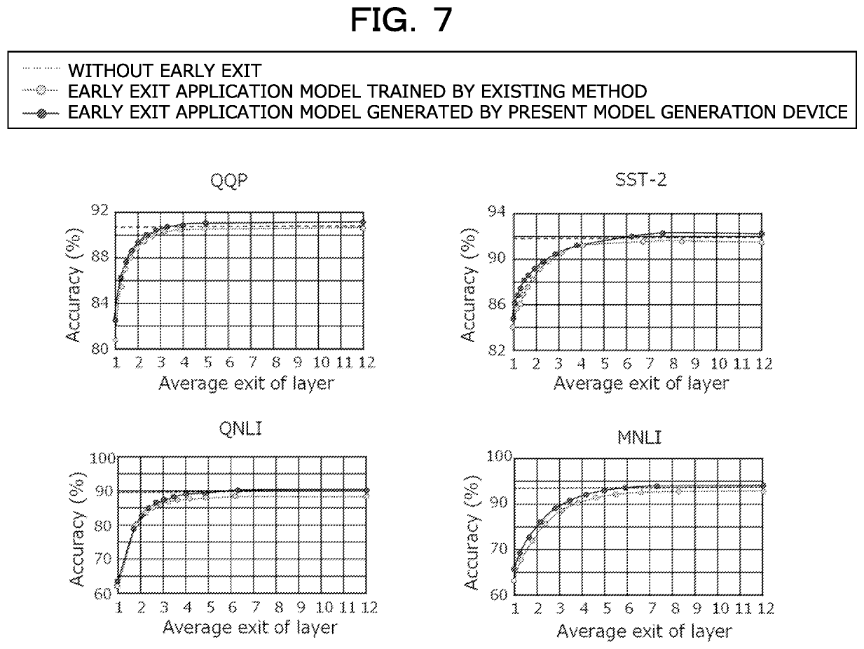

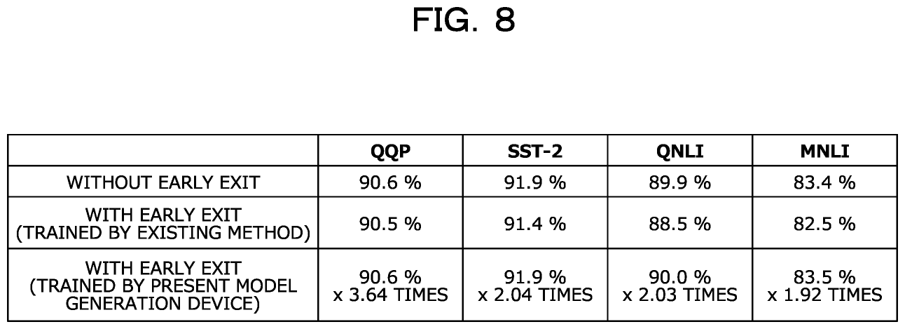

FIGS. 7 and 8 are diagrams each illustrating inference accuracy of a model trained by the model generation device 1 as the exemplary embodiment in comparison with a model trained by an existing method.

In those FIGS. 7 and 8, the inference accuracy of each layer in a case of using a GLUE task is illustrated by comparing a model generated by the present model generation device 1, an early exit application model trained by the method described in the related art mentioned above (which is referred to as an existing method in FIGS. 7 and 8), and a model without the early exit. Those FIGS. 7 and 8 illustrate examples in which fine-tuning is carried out using individual tasks of QQP, SST-2, QNLI, and MNLI of the GLUE tasks. The GLUE is an abbreviation for general language understanding evaluation.

FIG. 7 illustrates graphs indicating a relationship between inference accuracy (Accuracy) of a BERT base (BERT_base) of a GLUE task development set and an average exit layer. Note that a layer 1 represents a layer closest to the input, and a layer 12 represents a final layer.

It may be seen that the inference accuracy of the model trained by the present model generation device 1 improves even when any of the QQP, SST-2, QNLI, and MNLI tasks is used.

FIG. 8 illustrates comparison of an inference speed-up rate for each task of the QQP, SST-2, QNLI, and MNLI illustrated in FIG. 7 among the model generated by the present model generation device 1, the early exit application model trained by the method described in the related art mentioned above, and the model without the early exit.

Note that, in this FIG. 8, the inference speed-up rate of the model generated (trained) by the present model generation device 1 is measured by adjusting a threshold of uncertainty to have the inference accuracy equivalent to that of the case without the early exit.

Furthermore, among the values for the respective tasks of the QQP, SST-2, QNLI, and MNLI regarding the case with the early exit (trained by the present model generation device) in FIG. 8, the upper values (% values) represent accuracy, and the lower values represent inference speed-up rates.

As illustrated in those FIGS. 7 and 8, it may be seen that the inference speed-up with the inference accuracy equivalent to that in the case without the early exit may be achieved according to the model trained by the present model generation device 1.

### (C) OTHERS

Additionally, the disclosed technique is not limited to the embodiment described above, and various modifications may be made and implemented in a range without departing from the spirit of the present embodiment.

For example, while the termination condition of the training of each head by the first fine-tuning processing unit 5 or the second fine-tuning processing unit 6 is that the number of times of training set by the user is reached in the embodiment described above, the embodiment is not limited to this.

For example, the termination condition of the training of each head by the first fine-tuning processing unit 5 or the second fine-tuning processing unit 6 may be that the model inference accuracy reaches the accuracy set by the user.

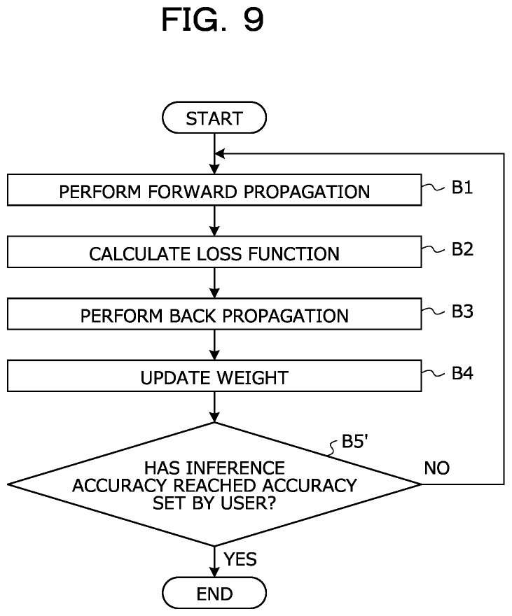

FIG. 9 is a flowchart (steps B1 to B5′) illustrating a first variation of the training method of the training target model by the first fine-tuning processing unit 5 and the second fine-tuning processing unit 6.

Note that, in the drawing, processing denoted by the same reference sign as the aforementioned reference sign indicates similar processing, and thus description thereof will be omitted.

In step B5′, the first fine-tuning processing unit 5 or the second fine-tuning processing unit 6 checks whether the model inference accuracy after the weight update has reached the accuracy (threshold) set by the user.

As a result of the checking, if the model inference accuracy after the weight update has not reached the accuracy (threshold) set by the user (see NO route of step B5′), it is determined that the termination condition is not satisfied, and the process returns to step B1.

On the other hand, if the model inference accuracy after the weight update has reached the accuracy (threshold) set by the user (see YES route of step B5′), it is determined that the termination condition is satisfied, and the process is terminated.

Furthermore, the termination condition of the training of each head by the first fine-tuning processing unit 5 or the second fine-tuning processing unit 6 may be that the model inference accuracy has become lower than the previous time (at the time of one preceding training).

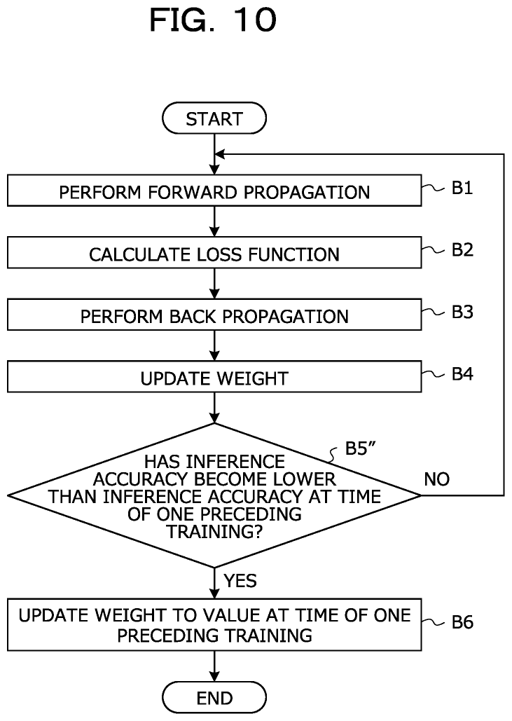

FIG. 10 is a flowchart (steps B1 to B5″ and B6) illustrating a second variation of the training method of the training target model by the first fine-tuning processing unit 5 and the second fine-tuning processing unit 6.

Note that, in the drawing, processing denoted by the same reference sign as the aforementioned reference sign indicates similar processing, and thus description thereof will be omitted.

In step B5″, the first fine-tuning processing unit 5 or the second fine-tuning processing unit 6 checks whether the model inference accuracy after the weight update has become lower than the inference accuracy in the one preceding training, for example, the model inference accuracy after the weight update of the previous time.

As a result of the checking, if the model inference accuracy after the weight update is the same as or improved from the inference accuracy in the one preceding training (see NO route of step B5″), it is determined that the termination condition is not satisfied, and the process returns to step B1.

On the other hand, if the model inference accuracy after the weight update has become lower than the inference accuracy in the one preceding training (see YES route of step B5″), it may be determined that the termination condition is satisfied.

In step B6, the first fine-tuning processing unit 5 or the second fine-tuning processing unit 6 updates the value updated in step B4 using the value of the weight before the update (weight updated in one preceding training). Thereafter, the process is terminated.

Furthermore, although the example in which the output layer of the machine learning model is a classifier has been exemplified in the embodiment described above, the embodiment is not limited to this.

Furthermore, the present embodiment may be implemented and manufactured by those skilled in the art according to the disclosure described above.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a machine learning program for causing a computer to execute a process comprising:
for a machine learning model that includes a plurality of preliminarily trained layers, a first output layer formed according to a downstream task and coupled to a final layer of the plurality of layers, and a plurality of second output layers that is coupled to respective outputs of layers other than the final layer of the plurality of layers and has a same configuration as the first output layer,
training only the first output layer and the second output layer of the machine learning model using the downstream task; and
training the entire machine learning model that includes the first output layer and the second output layer using the downstream task.

2. The non-transitory computer-readable recording medium according to claim 1, the recording medium storing the machine learning program for causing the computer to execute the process further comprising:
for a preliminarily trained model that includes the plurality of preliminarily trained layers, replacing an output layer coupled to the final layer of the plurality of layers with the first output layer formed according to the downstream task; and
coupling the respective second output layers that have the same configuration as the first output layer to the respective outputs of the layers other than the final layer of the plurality of layers to generate the machine learning model.

3. A machine learning method comprising:
for a machine learning model that includes a plurality of preliminarily trained layers, a first output layer formed according to a downstream task and coupled to a final layer of the plurality of layers, and a plurality of second output layers that is coupled to respective outputs of layers other than the final layer of the plurality of layers and has a same configuration as the first output layer,
training only the first output layer and the second output layer of the machine learning model using the downstream task; and
training the entire machine learning model that includes the first output layer and the second output layer using the downstream task.

4. The machine learning method according to claim 3, further comprising:
for a preliminarily trained model that includes the plurality of preliminarily trained layers, replacing an output layer coupled to the final layer of the plurality of layers with the first output layer formed according to the downstream task; and
coupling the respective second output layers that have the same configuration as the first output layer to the respective outputs of the layers other than the final layer of the plurality of layers to generate the machine learning model.
